(19) United States
(12) Patent Application Publication
(10) Pub. No.: US 2025/0326015 A1
(43) Pub. Date: Oct. 23, 2025

(54) WASTE TREATMENT APPARATUS USING SUBCRITICAL WATER

(71) Applicant: Seung Woo Han, Seoul (KR)

(72) Inventor: Seung Woo Han, Seoul (KR)

(21) Appl. No.: 18/639,679

(22) Filed: Apr. 18, 2024

(51) Int. Cl. B09B 3/45; B01F 27/70; B01F 101/25

(52) U.S. Cl. CPC B09B 3/45; B01F 27/70; B01F 2101/25

(57) ABSTRACT

Disclosed is a waste treatment apparatus using subcritical water, in which a treatment tank includes a tank body forming an internal space to receive raw materials to be treated, such as waste, and including a waste inlet for inputting the waste and a product outlet for discharging products, and treats the waste with steam having high temperature and high pressure supplied from a steam supplying unit capable of supplying the steam to the tank body, wherein the tank body is shaped like a sphere. Thus, there is provided a waste treatment apparatus using subcritical water, in which the spherical treatment tank is provided to effectively input, discharge, etc. waste to be treated or products, and more effectively and reliably treat the waste, and a sphere shape increases heat transfer efficiency and provides stable mixing in the process of disposing of waste.

### BACKGROUND OF THE INVENTION

### Field of the Invention

The disclosure relates a waste treatment apparatus using subcritical water, and more particularly to a waste treatment apparatus using subcritical water, which has a treatment structure shaped to increase efficiency in a process of treating waste, and is improved in structure to operate stably.

### Description of the Related Art

Human beings have been continually developing in the direction of improving the quality of life according to changes in socio-economic or cultural environments.

Such development requires energy consumption, and the energy consumption and living generate various types of waste.

Meanwhile, fossil fuels are energy resources essential for modern society, and have been produced from generation to generation. However, the fossil fuels are not infinitely available because they are not renewable. Further, waste generated when burning the fossil fuels cause environmental pollution. Accordingly, research on energy sources to replace the fossil fuels has been carried out for a long time.

To treat the waste and turn it into resources, various methods have been devised.

One of such various waste treatment methods is to use subcritical water for hydrolyzing the waste.

Water is a liquid at room temperature and below atmospheric pressure, and boils and becomes a gas at 100° C. and below atmospheric pressure (1 atmosphere). However, water becomes a supercritical water that is neither the liquid nor the gas when exceeding a critical point, i.e., at a pressure above 220 MPa (about 220 bar) and a temperature above 374° C. Further, water just before this critical point is called the subcritical water.

Water is ionized by collisions between water molecules even at room temperature/atmospheric pressure, and the ionization progresses as a collision frequency becomes higher with rise in temperature. The ionization generates hydroxide ions (OH—), and the concentration of hydroxide ions (OH—) becomes very high in the critical water. This hydroxide ion hydrolyzes the peptide bond of proteins to produce subcritical amino acids. Lipids and carbohydrates are also subcritically processed into fatty acids and glucose respectively by the same mechanism.

With this principle, various ways to dispose of waste have been proposed.

However, it is desired to implement a treatment system that has a more effective structure to reliably treat and recycle various types of waste.

### Documents of Related Art

Korean Patent Publication No. 10-2434206 (published on Aug. 19, 2022)
Japanese Patent Publication No. 6409237 (published on Oct. 24, 2018)

### SUMMARY OF THE INVENTION

An aspect of the disclosure is to provide a waste treatment apparatus using subcritical water, which includes a spherical treatment tank to effectively input, discharge, etc. waste to be treated or products, and more effectively and reliably treat the waste.

Further, another aspect of the disclosure is to provide a waste treatment apparatus using subcritical water, which is shaped like a sphere to increase heat transfer efficiency and provide stable mixing in the process of disposing of waste, thereby reducing energy and operating costs and thus improving economic efficiency.

Further, still another aspect of the disclosure is to provide a waste treatment apparatus using subcritical water, which eliminates or minimize germs such as viruses or odors generated in the process of disposing of waste.

Further, still another aspect of the disclosure is to provide a waste treatment apparatus using subcritical water, which covers a very wide range of waste such as agricultural waste, construction waste, waste paint, and medical waste in addition to organic waste.

Further, still another aspect of the disclosure is to provide a waste treatment apparatus using subcritical water, which minimizes a space required to treat the same amount and type of waste.

Further, still another aspect of the disclosure is to provide a waste treatment apparatus using subcritical water, which is shaped like a sphere to increase heat transfer efficiency, facilitate a waste mixing operation therein, and simply and easily discharge the products while minimizing residues.

Further, still another aspect of the disclosure is to provide a waste treatment apparatus using subcritical water, which facilitates recycling of products.

According to an embodiment of the disclosure, there is provided a waste treatment apparatus using subcritical water, including: a treatment tank that includes a tank body forming an internal space to receive raw materials to be treated, such as waste, and including a waste inlet for inputting the waste and a product outlet for discharging products, and treats the waste with steam having high temperature and high pressure supplied from a steam supplying unit capable of supplying the steam to the tank body, wherein the tank body is shaped like a sphere.

Further, the apparatus may further include: a driver configured to transfer power to a rotary shaft coupled in a direction transverse to a diameter of the tank body and rotatable with respect to the tank body; and a mixer coupled to the rotary shaft and configured to mix waste received in the tank body.

Further, the mixers may include shaft clamps coupled to the rotary shaft and arranged at set distances along a lengthwise direction of the rotary shaft, a pair of mixer shafts extending from the shaft clamp toward an inner circumferential surface of the tank body in a direction transverse to the rotary shaft and facing each other across a central axis of the rotary shaft, and mixer wings extending from an end portion of each mixer shaft and bending to be adjacent to the inner circumferential surface of the tank body.

Further, the apparatus may further include a clamp bracket coupled to the shaft clamp and extending to have a set length in a direction transverse to the rotary shaft to support the mixer shaft shaped like a rod.

Further, the mixer shaft may have a cross-section having a ‘+’ shape, and the clamp bracket may have a quadrangular cross-section hollowed out to accommodate the mixer shaft.

Further, the mixer shaft may include a pair of first mixer shafts coupled to the shaft clamps spaced apart at a first distance from a vertical center axis of the tank body and facing each other across the vertical center axis, and a pair of second mixer shafts coupled to the shaft clamps spaced apart at a second distance from the first mixer shaft and facing each other across the vertical center axis, and the pair of first mixer shafts and the pair of second mixer shafts may be misaligned by 90 degrees when viewed from the center axis of the rotary shaft, and the first mixer shaft and the second mixer shaft are be misaligned by 90 degrees when viewed from the center axis of the rotary shaft.

The mixer wings coupled to the mixer shaft may include a first mixer wing coupled to and extending from the mixer shaft, and a second mixer wing bending and extending from the first mixer wing, the first mixer wing may be bent in a range of 30 degrees±5% with respect to a line parallel to the vertical center axis, and the second mixer wing may be bent in a range of 15 degrees±5% from the first mixer wing in a direction away from the line parallel to the vertical center axis.

Further, a line along which the second mixer wing is bent from the first mixer wing may be parallel to the vertical center axis.

According to the disclosure, there is provided a waste treatment apparatus using subcritical water, which includes a spherical treatment tank to effectively input, discharge, etc. waste to be treated or products, and more effectively and reliably treat the waste.

Further, there is provided a waste treatment apparatus using subcritical water, which is shaped like a sphere to increase heat transfer efficiency and provide stable mixing in the process of disposing of waste, thereby reducing energy and operating costs and thus improving economic efficiency.

Further, there is provided a waste treatment apparatus using subcritical water, which eliminates or minimize germs such as viruses or odors generated in the process of disposing of waste.

Further, there is provided a waste treatment apparatus using subcritical water, which covers a very wide range of waste such as agricultural waste, construction waste, waste paint, and medical waste in addition to organic waste.

Further, there is provided a waste treatment apparatus using subcritical water, which minimizes a space required to treat the same amount and type of waste.

Further, there is provided a waste treatment apparatus using subcritical water, which is shaped like a sphere to increase heat transfer efficiency, facilitate a waste mixing operation therein, and simply and easily discharge the products while minimizing residues.

Further, there is provided a waste treatment apparatus using subcritical water, which facilitates recycling of products.

### BRIEF DESCRIPTION OF THE DRAWINGS

FIG. 1 illustrates a schematic process diagram of a waste treatment apparatus according to an embodiment of the disclosure,

FIGS. 2A to 2C are plan, front and lateral views of a treatment tank,

FIGS. 3A to 3C are plan, front and lateral views showing that a mixer is coupled to the inside of a tank body, and

FIGS. 4A to 4C are perspective and partial cross-sectional views showing the detailed configurations of the mixer.

### DETAILED DESCRIPTION OF THE INVENTION

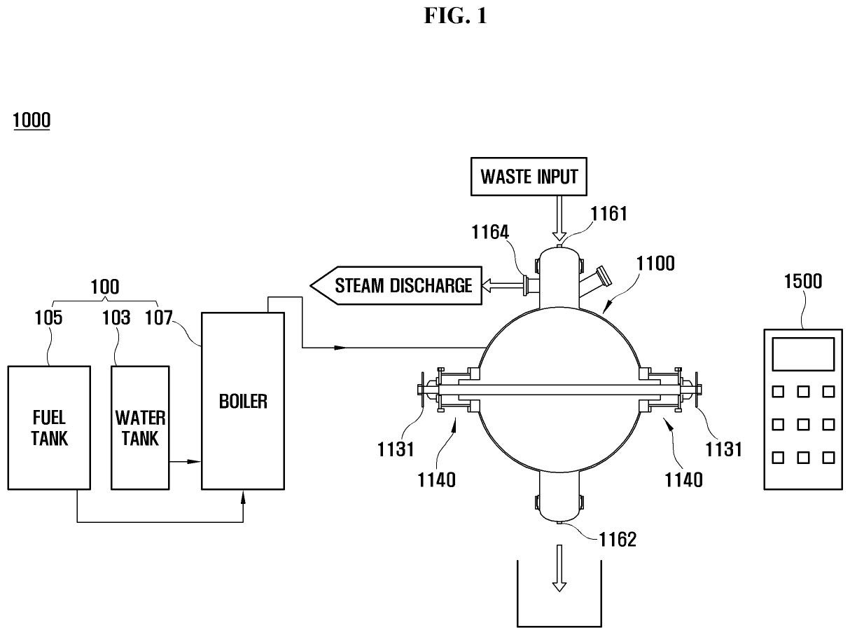

A waste treatment apparatus using subcritical water (hereinafter referred to as a ‘waste treatment apparatus 1000’) according to an embodiment of the disclosure will be described in detail with reference to FIGS. 1 to 4C.

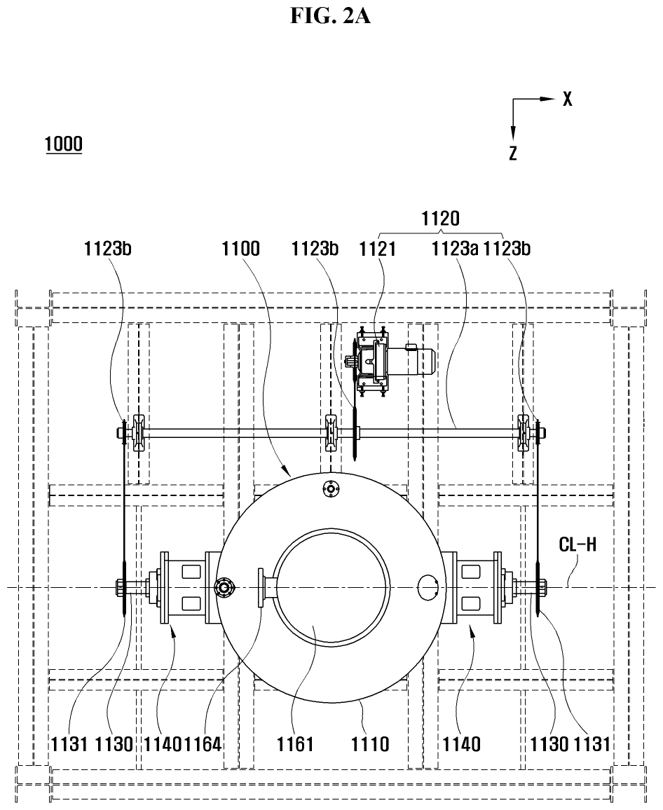

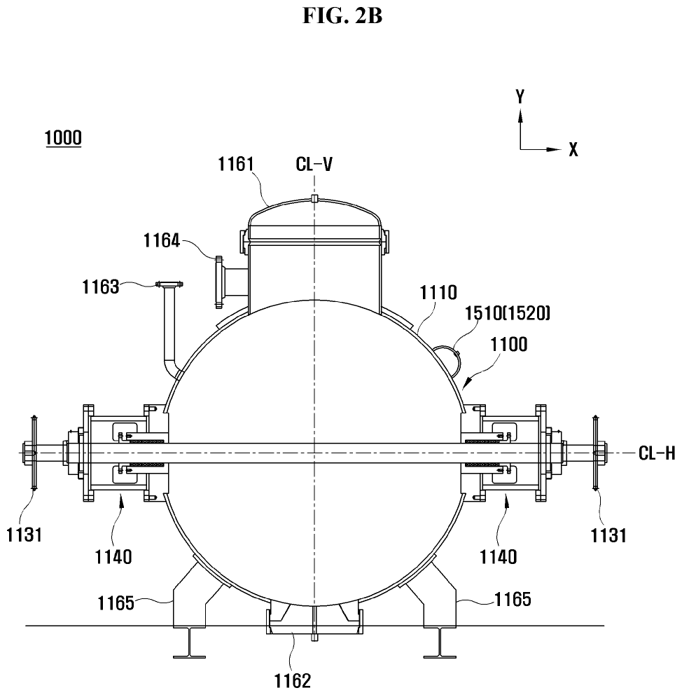

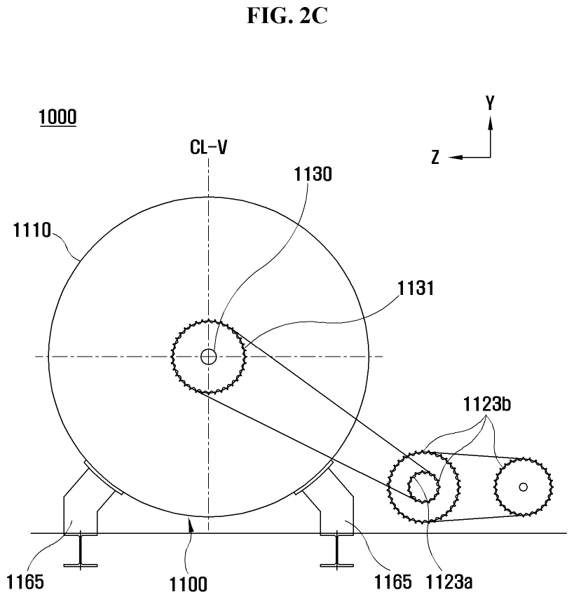

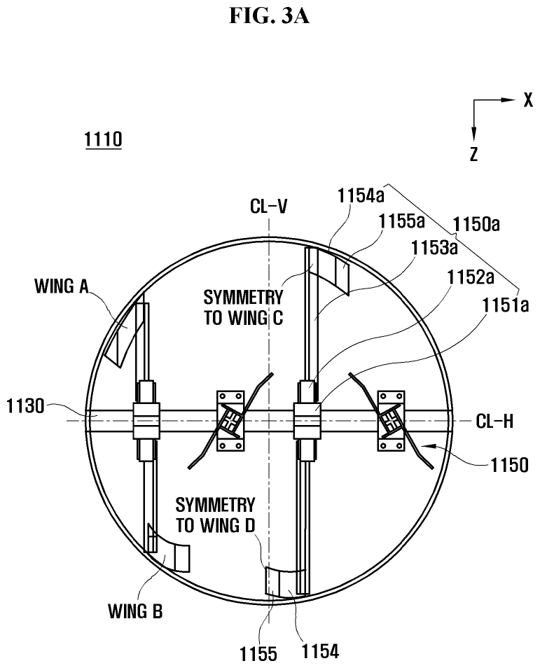

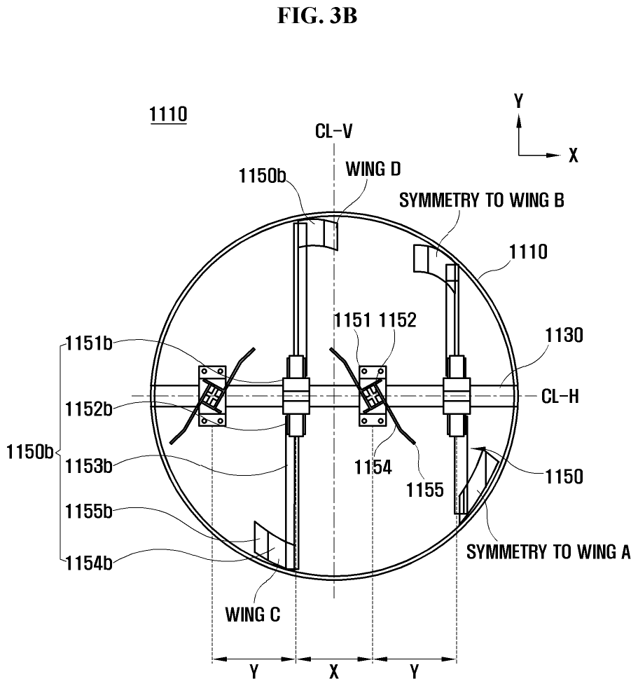

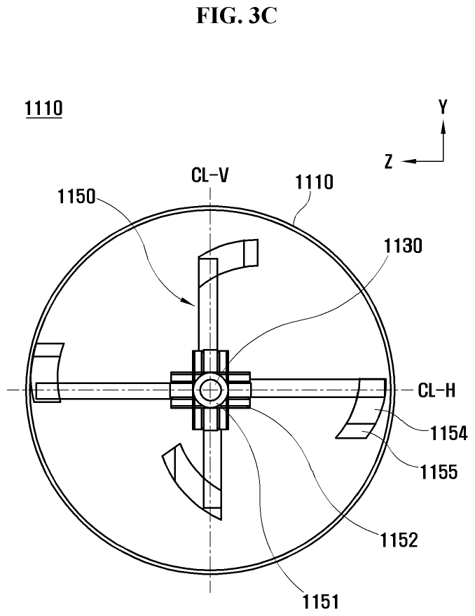

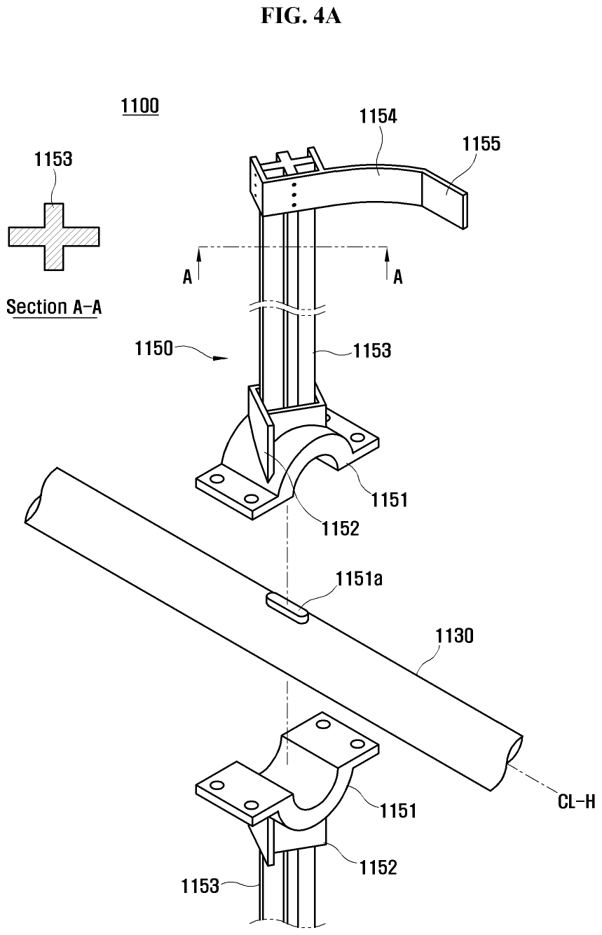

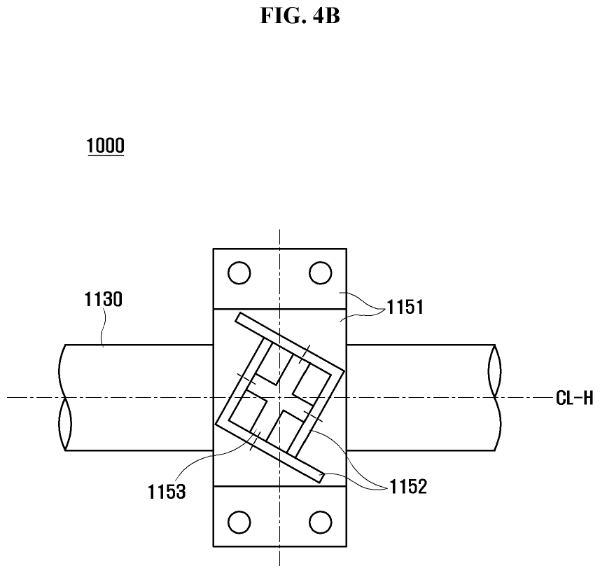

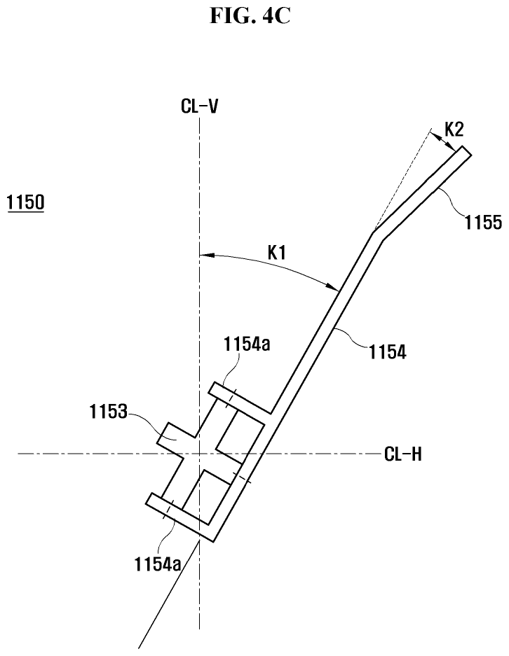

FIG. 1 illustrates a schematic process diagram of a waste treatment apparatus according to an embodiment of the disclosure, FIGS. 2A to 2C are plan, front and lateral views of a treatment tank, FIGS. 3A to 3B are plan, front and lateral views showing that a mixer is coupled to the inside of a tank body, and FIGS. 4A to 4C are perspective and partial cross-sectional views showing the detailed configurations of the mixer.

The disclosure may be modified in various ways, and have various embodiments, and thus aspects (or embodiments) are described in detail in the following description. It should be understood, however, that the disclosure is not intended to be limited to particular forms disclosed, but on the contrary, is intended to cover all modifications, equivalents, and alternatives falling within the spirit and scope of the disclosure.

In the drawings, the same reference numerals, and in particular, reference numerals having the same tens and ones digits, reference numerals having the same tens digits, reference numerals having the same ones digits and letters represent members having the same function or similar functions. Unless stated otherwise, the members referred to by the reference numerals in the drawings may be identified as members corresponding to these criteria.

In the drawings, the sizes or thicknesses of the components are exaggerated to be large (or thick), small (or thin, or simplified in consideration of convenience of understanding of the components, or are simplified to express the components. However, the scope of protection of the disclosure should not be construed as being limited thereby.

Terms used in this specification are merely adopted to explain specific implementation examples (aspects) (or embodiments), and are not intended to limit the disclosure. As used herein, the singular forms “a”, “an”, and “the” are intended to include the plural forms as well, unless context clearly indicates otherwise. In this specification, the terms “include”, “comprise”, and the like are intended to indicate that characteristics, figures, steps, operations, constituents, and components disclosed in the specification or combinations thereof exist. The terms “include”, “comprise”, and the like should be understood as not precluding possibility of existence or addition of one or more other characteristics, figures, steps, operations, constituents, components, or combinations thereof.

Unless stated otherwise, all terms used herein, including technical or scientific terms, have the same meaning as commonly understood by those having ordinary skill in the art to which the disclosure pertains. Terms such as those defined in commonly used dictionaries are to be interpreted as having a meaning consistent with the meaning in the context of the related art and are not to be construed as ideal or overly formal in meaning unless expressly so-defined in the disclosure.

In a waste treatment apparatus 1000 according to the disclosure, a treatment tank 1100 includes a tank body 1110 forming an internal space to receive waste or the like raw materials to be treated, and treats waste with steam having high temperature and high pressure supplied from a steam supplying unit 100 capable of supplying the steam having high temperature and high pressure to the tank body 1110, in which the tank body 1110 is shaped like a sphere and includes a waste inlet 1161 for inputting the waste, and a product outlet 1162 for discharging treated waste.

Hereinafter, for case of description and understanding, referring to FIGS. 2A to 2C, the leftward and rightward directions in the plan view of FIG. 2A will be regarded as ‘X’ axial directions, the upward and downward directions in the plan view of FIG. 2A will be regarded as ‘Z’ axial directions, and the directions perpendicular to the ‘X-Z’ plane in the plan view of FIG. 2A will be regarded as ‘Y’ axial directions.

In the waste treatment apparatus 1000 according to the disclosure, when steam having high temperature and high pressure is supplied from the steam supplying unit 100 to maintain an environment of about 20 to 26 atmospheres in the airtight and sealed treatment tank 1100, subcritical conditions are added to the inside of the tank body 1110. Under these conditions, the waste, i.e., the raw material is treated in the internal space of the tank body 1110.

The steam supplying unit 100 supplies the steam so that the inside of the tank body 1110 can reach the subcritical conditions (temperature of about 200 to 225° C. and atmospheric pressure of about 2 to 2.6 MPa). To this end, the steam supplying unit 110 may include a water tank 103 to store water, a fuel tank 105 to store fuel, and a boiler 107 to generate steam having high temperature and high pressure. Although not shown, the steam supplying unit 100 may further include well-known means such as pumps to supply fuel and water to the boiler 107, and a storage tank to recover and recycle hot water or heated steam.

The treatment tank 1100 may include the tank body 1110 shaped like a sphere, receiving waste, and hydrolyzing the waste under high temperature and high pressure; a driver 1120 providing power for driving a rotary shaft 1130 rotating with respect to the tank body 1110 inside the tank body 1110 and a mixer 1150 coupled to the rotary shaft 1130 to rotate, and a shaft sealer 1140 maintaining airtightness between the tank body 1110 and the rotary shaft 1130 in a portion where the rotary shaft 1130 protrudes outwards.

The tank body 1110 may be made of a material that can withstand high temperature and high pressure, such as stainless steel.

The tank body 1110 is formed with the waste inlet 1161 at the top to input waste, and the product outlet 1162. Likewise, the waste inlet 1161 and the product outlet 1162 also have a substantial structure such as a hatch to maintain the airtightness in the process of disposing of the waste.

The treatment tank 1100 couples with one or multiple pressurizing steam inlet 1163, a stream outlet 1164 for lowering increased internal pressure, and a plurality of tank legs 1165 for firmly supporting the tank body 1110 and accessories to a construction.

Although not shown, a safety valve may be used in discharging the steam to lower the increased internal pressure of the tank body 1110 when the internal pressure of the tank body 1110 increases above a setting pressure, thereby solving a problem that may arise due to the increase in the pressure of the tank body 1110.

The driver 1120 may include a power generation member 1121 which includes a motor rotating by power supplied from the outside, and a reducer reducing the speed of the motor; and a power transmission member 1123 which includes a sprocket 1123a and a driven shaft 1123b to transmit the power generated by the power generation member 1121 to the rotary shaft 1130.

In other words, the power is transmitted in order of the power generation member 1121—the center sprocket 1123b—the driven shaft 1123a—the side sprocket 1123b—the sprocket 1131—the rotary shaft 1130.

Meanwhile, a controller 1500 may control the internal pressure, temperature, etc. in connection with the steam supplying unit 100, and control the rotation speed, rotation time, etc. of the mixer 1150. In addition, the controller 1500 may include a pressure gauge 1510 and a thermometer 1520 to detect the internal pressure and temperature of the tank body 1110, respectively.

As shown in FIGS. 3A to 4C, the mixers 1150 coupled to the rotary shaft 1130 may be provided to mix the waste received in the tank body 1110.

The mixers 1150 may include shaft clamps 1151 coupled to the rotary shaft 1130 and arranged at set distances (see ‘X’ and ‘Y’ in FIG. 3B) along the lengthwise direction of the rotary shaft 1130, a pair of mixer shafts 1153 extending from the shaft clamp 1151 toward the inner circumferential surface of the tank body 1110 in a direction transverse to the rotary shaft 1130 and facing each other across the central axis of the rotary shaft 1130, and mixer wings 1154 and 1155 extending from the end portion of each mixer shaft 1153 and bending to be adjacent to the inner circumferential surface of the tank body 1110.

In addition, the mixer 1150 may further include a clamp bracket 1152 coupled to the shaft clamp 1151 and extending to have a set length in a direction transverse to the rotary shaft 1130 to support the mixer shaft 1153 shaped like a rod.

The shaft clamp 1151 may be coupled to the rotary shaft 1130 by a key 1151a, as shown in FIG. 4A, as necessary to rotate together with the rotary shaft 1130.

Meanwhile, the cross-section of the mixer shaft 1153, taken along line A-A of FIG. 4A, may have a ‘+’ shape, and the clamp bracket 1152 may have a quadrangular cross-section hollowed out to accommodate the mixer shaft 1153. The mixer shaft 1153 is slidably coupled to the clamp bracket 1152 and then firmly coupled to the clamp bracket 1152 by fastening means such as bolts.

With this structure, the deformation of the mixer shaft 1153 due to torsion, tensile force, etc. is minimized even though force, which is received in the mixer wings 1154 and 1155 coupled to the end portion of the mixer shaft 1153 as the mixer wings 1154 and 1155 are rotated coming into contact with waste, is transmitted from the mixer wings 1154 and 1155 to the mixer shaft 1153.

The mixer shaft 1153 and the clamp bracket 1152 are coupled by well-known fastening means such as bolts.

The mixer shafts 1153 include a pair of first mixer shafts coupled to the shaft clamps 1151 spaced apart at a first distance (see ‘X’ in FIG. 3B) from a vertical center axis (in the ‘Y’ axial direction) of the tank body 1110 and facing each other across the vertical center axis (i.e., a pair of long mixer shafts provided inwards close to a vertical center axis in FIGS. 3A and 3B), and a pair of second mixer shafts coupled to the shaft clamps spaced apart at a second distance (see ‘Y’ in FIG. 3B) from the first mixer shaft 1153 and facing each other across the vertical center axis (i.e., a pair of short mixer shafts provided outwards away from the vertical center axis in FIGS. 3A and 3B). The pair of first mixer shafts and the pair of second mixer shafts may be misaligned by 90 degrees when viewed from the center axis of the rotary shaft 1130, and the first mixer shaft and the second mixer shaft may be misaligned by 90 degrees when viewed from the center axis of the rotary shaft 1130.

With this structure, the waste received in the sphere is entirely and reliably mixed while the mixer shaft 1153 rotates.

The mixer wings 1154 and 1155 coupled to the mixer shaft 1153 include a first mixer wing 1154 coupled to and extending from the mixer shaft 1153, and a second mixer wing 1155 bending and extending from the first mixer wing 1154. The first mixer wing 1154 may be bent in a range of 30 degrees±5% with respect to a line parallel to the vertical center axis. The second mixer wing 1155 may be bent in a range of 15 degrees±5% from the first mixer wing 1154 in a direction away from the line parallel to the vertical center axis.

Referring to the contents and shapes of the ‘wing A’, the ‘wing B’, the ‘wing C’ and the ‘wing D’ and the ‘symmetry to the wing A’ the ‘symmetry to the wing B’, the ‘symmetry to the wing C’ and the ‘symmetry to the wing D’ in FIGS. 3A to 3B, the foregoing descriptions will be more effectively understood. For example, refer to the ‘symmetry to the wing C” 1150a in FIG. 3A and the ‘wing C’ 1150b in FIG. 3B for better understanding.

In other words, such arrangement of the wings enables the waste to be effectively mixed, blended and agitated without leaning to one side in the sphere having a symmetrical structure with respect to the vertical center axis and the horizontal center axis.

In addition, a line along which the second mixer wing 1155 is bent from the first mixer wing 1154 may be parallel to the vertical center axis.

With this structure, while the rotary shaft 1130 is rotated forwardly or reversely, the waste inside the whole sphere is more effectively and reliably mixed and blended, and residues are minimized while discharging the products after the waste is treated. Because the products typically contains water, almost no products remains inside the tank body 1110 due to the spherical structure of the tank body 1110.

In addition, if lines parallel to the vertical center axis are drawn from the ends of the mixer wings to the rotary shaft 1130, the mixer wings are disposed and coupled to the mixer shaft 1153 so that the lines from the ends of the mixer wings can be overlapped with each other on the rotary shaft 1130.

The mixer wing includes a pair of wing skirts 1154a (see FIG. 4C) at the ends thereof, so that the mixer wing can be coupled to the mixer shaft 1153 by fastening means such as bolts.

Although not described, a reference numeral of ‘CL-H’ indicates the horizontal center axis in the X axial direction, and a reference numeral of ‘CL-V’ indicates the vertical center axis in the Y axial direction.

Referring to FIGS. 1 to 3C, the waste treatment apparatus 1000 with this configuration operates as follows.

First, a setting amount of waste to be treated is input to the waste inlet 1161, and then the waste inlet 1161 is tightly scaled.

Then, the controller 1500 controls the driver 1120 to drive the rotary shaft 1130 so that the mixer 1150 can mix, blend and agitate the waste inside the tank body 1110.

At the same time, the steam supplying unit 100 supplies steam heated to have high temperature and high pressure to the tank body 1110. By the steam supplied for a set period of time, the internal temperature and pressure of the tank body 1110 reach the subcritical area, and the waste that has been slowly decomposing since before reaching the subcritical area is completely treated as time passes. Of course, such a treatment time is varied depending on the type, state, amount, etc. of the waste.

When the treatment of the waste is completed, the stream outlet 1164 is slowly opened to relieve the pressure in the tank body 1110. Because the internal pressure of the tank body 1110 is very high, a large amount of steam is discharged to the outside, and odors and the like generated in the process of treating the waste are discharged along with the steam. As necessary, such odors and the like may be guided to and removed in water. Further, a cyclone or the like may be used.

When the internal pressure of the tank body 1110 is lowered to atmospheric pressure, the product outlet 1162 at the bottom is opened to transfer the products to a receiving means. As necessary, the products received in the receiving means may be recycled by the following processes.

In addition, when the waste treatment apparatus 1000 according to the disclosure is used, the treatment requires only fuel (kerosene, heavy oil) for the boiler, water (or groundwater), electricity of low prices, and the like energy, thereby realizing low operating coasts based on treatment costs of 30 to 40 won per kilogram.

Although it is varied depending on the type of waste, the waste treatment apparatus 1000 according to the disclosure can treat 1 to six tons of waste at once in just 30 to 40 minutes, thereby achieving very good performance for its costs.

In addition, the finally discharged products include water and solids. The solids may be hydrolyzed and processed with an enzyme or the like, and then very effectively used as eco-friendly fertilizers, fertilizer additives, etc. for a variety of purposes.

Thus, according to the disclosure, there is provided a waste treatment apparatus using subcritical water, which includes a spherical treatment tank to effectively input, discharge, etc. waste to be treated or products, and more effectively and reliably treat the waste.

Further, there is provided a waste treatment apparatus using subcritical water, which is shaped like a sphere to increase heat transfer efficiency and provide stable mixing in the process of disposing of waste, thereby reducing energy and operating costs and thus improving economic efficiency.

Further, there is provided a waste treatment apparatus using subcritical water, which eliminates or minimize germs such as viruses or odors generated in the process of disposing of waste.

Further, there is provided a waste treatment apparatus using subcritical water, which covers a very wide range of waste such as agricultural waste, construction waste, waste paint, and medical waste in addition to organic waste.

Further, there is provided a waste treatment apparatus using subcritical water, which minimizes a space required to treat the same amount and type of waste.

Further, there is provided a waste treatment apparatus using subcritical water, which is shaped like a sphere to increase heat transfer efficiency, facilitate a waste mixing operation therein, and simply and easily discharge the products while minimizing residues.

Further, there is provided a waste treatment apparatus using subcritical water, which facilitates recycling of products.

Although various embodiments of the disclosure are illustrated and described herein, various changes can be made without departing from the principle or spirit of the disclosure by a person having ordinary knowledge in the art to which the disclosure pertains. The scope of the disclosure is defined by the appended claims and their equivalents.

What is claimed is:

1. A waste treatment apparatus using subcritical water, comprising:
a treatment tank that comprises a tank body forming an internal space to receive raw materials to be treated, such as waste, and comprising a waste inlet for inputting the waste and a product outlet for discharging products, and treats the waste with steam having high temperature and high pressure supplied from a steam supplying unit capable of supplying the steam to the tank body,
wherein the tank body is shaped like a sphere.

2. The apparatus of claim 1, further comprising:
a driver configured to transfer power to a rotary shaft coupled in a direction transverse to a diameter of the tank body and rotatable with respect to the tank body; and
a mixer coupled to the rotary shaft and configured to mix waste received in the tank body.

3. The apparatus of claim 2, wherein the mixers comprise shaft clamps coupled to the rotary shaft and arranged at set distances along a lengthwise direction of the rotary shaft, a pair of mixer shafts extending from the shaft clamp toward an inner circumferential surface of the tank body in a direction transverse to the rotary shaft and facing each other across a central axis of the rotary shaft, and mixer wings extending from an end portion of each mixer shaft and bending to be adjacent to the inner circumferential surface of the tank body.

4. The apparatus of claim 3, further comprising a clamp bracket coupled to the shaft clamp and extending to have a set length in a direction transverse to the rotary shaft to support the mixer shaft shaped like a rod.

5. The apparatus of claim 4, wherein the mixer shaft has a cross-section having a ‘+’ shape, and the clamp bracket has a quadrangular cross-section hollowed out to accommodate the mixer shaft.

6. The apparatus of claim 3, wherein
the mixer shaft comprises a pair of first mixer shafts coupled to the shaft clamps spaced apart at a first distance from a vertical center axis of the tank body and facing each other across the vertical center axis, and a pair of second mixer shafts coupled to the shaft clamps spaced apart at a second distance from the first mixer shaft and facing each other across the vertical center axis, and
the pair of first mixer shafts and the pair of second mixer shafts are misaligned by 90 degrees when viewed from the center axis of the rotary shaft, and the first mixer shaft and the second mixer shaft are be misaligned by 90 degrees when viewed from the center axis of the rotary shaft.

7. The apparatus of claim 4, wherein
the mixer wings coupled to the mixer shaft comprise a first mixer wing coupled to and extending from the mixer shaft, and a second mixer wing bending and extending from the first mixer wing, and
the first mixer wing is bent in a range of 30 degrees±5% with respect to a line parallel to the vertical center axis, and the second mixer wing is bent in a range of 15 degrees±5% from the first mixer wing in a direction away from the line parallel to the vertical center axis.

8. The apparatus of claim 7, wherein a line along which the second mixer wing is bent from the first mixer wing is parallel to the vertical center axis.
